(19) United States
(12) Patent Application Publication
(10) Pub. No.: US 2015/0333501 A1
(43) Pub. Date: Nov. 19, 2015

(54) Wind Turbine and Method for Controlling the Electrical Moment of a Wind Turbine by Closed-Loop Control in the Event of a Grid Fault

(71) Applicant: SENVION SE., Hamburg (DE)

(72) Inventors: Jens Geisler, Rendsburg (DE); Stefan Schrader, Kiel (DE); Jens Fortmann, Berlin (DE)

(21) Appl. No.: 14/652,874

(22) PCT Filed: Dec. 16, 2013
(86) PCT No.: PCT/EP2013/076687

§ 371 Date: Jun. 17, 2015

(30) Foreign Application Priority Data
Dec. 20, 2012 (DE) 10 2012 224 067.5

(51) Int. Cl. H02H 7/06

(52) U.S. Cl. CPC H02H 7/067

(57) ABSTRACT

The invention relates to a method for controlling the electrical moment of a wind turbine by closed-loop control in the event of a grid fault. A fall in voltage that is outside the limits of normal operation is discovered. A moment closed-loop controller which determines a target value for the electrical moment of the wind turbine, is operated. A moment ramp is initialized. The target value of the moment closed-loop controller is compared with the moment ramp and the lesser value is selected as a moment setpoint value. The electrical moment of the wind turbine is set on the basis of the moment setpoint value. The invention additionally relates to a wind turbine suitable for implementing the method. The invention makes it possible, on the one hand, to achieve a rapid restoration of the power after the end of the grid fault, while, on the other hand, the loads for the wind turbine are kept within limits.

The invention relates to a wind turbine, and to a method for controlling the electrical moment of a wind turbine by closed-loop control in the event of a grid fault.

### BACKGROUND

In the event of a grid fault that is associated with a fall in voltage, the wind turbine is only able to output less electric power to the grid than in normal operation. It is only with the recovery of the voltage that the capacity of the grid is restored. According to the requirements of the grid operators, the wind turbines must again feed in full power within a short period of time after the recovery of the voltage. However, abrupt changes in the electrical load are associated with high mechanical loads for the wind turbine.

For the operation of the wind turbine in the event of a grid fault, it is therefore necessary to find a compromise that, on the one hand, meets the requirements of the grid operators and, on the other hand, keeps the loads for the wind turbine within acceptable limits. Known from DE 10 2007 060 958 is a method in which the closed-loop controller, which controls the electrical moment by closed-loop control in dependence on the rotational speed, is initialized to a predefined value after a grid fault. The closed-loop controller can then bring the wind turbine back, from a defined starting point, from a soft start to normal operation. Since, in the case of this method, the wind turbine is back in free closed-loop control after the grid fault, the duration of the return to normal operation is highly dependent on the external conditions. In view of increasingly more stringent prescriptions of the grid operators, it now takes too long until the wind turbine is again feeding in full power.

### SUMMARY

Proceeding from the stated prior art, the invention is based on the object of presenting a wind turbine and a method for controlling the torque of the wind turbine by closed-loop control, by means of which, on the one hand, the wind turbine rapidly returns to full energy infeed after the grid fault and, on the other hand, the loads for the wind turbine are kept within limits. The object is achieved with the features of the independent claims. Advantageous embodiments are given by the dependent claims.

In the case of the method according to the invention, a fall in voltage that is outside the limits of normal operation is discovered. A moment closed-loop controller, which determines a target value for the electrical moment of the wind turbine, is operated. A moment ramp is initialized, and the target value of the moment closed-loop controller is compared with the moment ramp. The lesser of the two values is selected as a moment setpoint value, and the electrical moment of the wind turbine is set on the basis of the moment setpoint value.

Firstly, some terms are to be explained. A moment ramp refers to a time-variable comparison value that is related to the electrical moment of the wind turbine and that increases, starting with an initial value. Upon the initialization, the moment ramp is set to the initial value, and the variation as a function of time is started.

If the electrical moment of the wind turbine is set “on the basis” of a moment setpoint value, it is possible, but not imperative, for the actual specified value for the electrical moment of the wind turbine to correspond directly to the moment setpoint value according to the invention. In many cases, the moment setpoint value determined by means of the method according to the invention is combined with yet more variables, in order to determine the specified value to which the electrical moment is actually set at the end.

The moment closed-loop controller may determine the target value in dependence on the difference between a setpoint rotational speed and an actual rotational speed of the wind turbine. Instead of directly processing the rotational speed values, the moment closed-loop controller may also depend on variables that are equivalent to rotational speed, i.e. on variables that allow the rotational speed to be deduced.

The invention opens up the possibility of using, after the grid fault, a closed-loop controller that returns the wind turbine to full power infeed within a very short period of time. The increasing requirements of the grid operators in respect of the restoration of the power infeed can thus be fulfilled. The problem of such high-speed closed-loop controllers occasionally changing the specified value so abruptly that the wind turbine, or parts of the wind turbine, more precisely the mechanical drive train of the wind turbine, is made to vibrate, is countered in that, upwardly, a limitation is drawn in by the moment ramp. Abrupt changes in the upward direction (i.e. in the direction of an increase in the electrical moment) are thus precluded by the moment ramp. In the downward direction, on the other hand, the closed-loop controller is allowed the required freedom of movement. The moment closed-loop controller is thus free to reduce the electrical moment if the wind has abated in the interim. The invention thus proposes a closed-loop control strategy by which the various, and to some extent conflicting, requirements after a grid fault are brought together in an advantageous balance.

The moment ramp is preferably configured such that it rises with a constant slope from an initial value to an end value. The slope may be calculated such that the period of time between the initial value and the end value is 0.1 s to 1 s, preferably 0.2 s to 0.5 s. The initial value may be in a defined ratio to the smallest voltage that is present during the fault. For example, the initial value may be between 0% and 80% relative to the electrical moment present before the fault. The end value may be, for example, between 80% of the electrical moment present before the fault and the maximum electrical moment provided for the respective wind turbine. The end value is typically the nominal moment (100%) of the wind turbine, such that, after the end of the ramp, the wind turbine is again back in normal (unlimited) operation. As soon as the end value has been attained, the moment ramp may change to a horizontal line, which corresponds to the end value. It is also possible for the wind turbine to change back to normal operation after the end value has been attained.

In an advantageous embodiment, the initial value of the moment ramp is determined in dependence on the characteristic of the grid fault. The moment ramp can consequently be adapted to the conditions during the specific grid fault. For example, the initial value may be set in dependence on the minimum value of the electrical moment that was present during the grid fault. This minimum value may be adopted directly as an initial value. Moreover, the initial value may be set in dependence on the duration of the fault.

In addition or as an alternative to this, the slope of the moment ramp may be determined in dependence on the characteristic of the grid fault. The slope of the moment ramp may also be set in dependence on the duration of the fault and/or in dependence on the minimum value of the electrical moment that was present during the grid fault.

In the moment closed-loop controller, a difference between a setpoint rotational speed and an actual rotational speed is processed as an input variable. The output variable of the moment closed-loop controller constitutes a target variable for the electrical moment of the wind turbine. Since the closed-loop controller is a high-speed closed-loop controller, the target variable may change abruptly, in the case of corresponding input variables, such that there is the risk of vibrations if the target variable were to be transferred directly, as a specified value, to a converter. Since the target value is compared with the moment ramp and the lesser of the two values is selected as a moment setpoint value, the moment closed-loop controller is limited upwardly by the moment ramp.

The moment closed-loop controller may be a closed-loop controller having a rising step-response, which means that the output variable rises with time, if the input variable remains constant. How the moment closed-loop controller is actually realized is not of importance for the invention. Preferably, the moment closed-loop controller comprises a conventional I component, which integrates the input variable linearly.

It is not precluded that the moment closed-loop controller also additionally has a P component, i.e. a component of the output variable that is proportional to the input variable. In an advantageous embodiment, however, the moment closed-loop controller is a pure I-controller, without further components. This is because it is precisely the I component that can cause particularly pronounced excursions after the grid fault, in that a large deviation between an actual rotational speed and a setpoint rotational speed is summed for a period of time. It has therefore been found to be particularly advantageous if the moment ramp is related to, precisely, an I component of the closed-loop controller.

A moment ramp related to a P component of the closed-loop controller may also constitute subject-matter of the method according to the invention. If the closed-loop controller comprises both an I component and a P component, a first moment ramp may be provided for the I component, and a second moment ramp may be provided for the P component.

Since uncontrollable conditions prevail during the grid fault, it is expedient to initialize the output variable of the moment closed-loop controller. The target value, which is the output variable of the moment closed-loop controller, may be set, for example, to zero, or to the lowest electrical moment that could still be applied during the grid fault. However, a certain amount of time then elapses before the I component has been sufficiently integrated in order to become effective. Preferably, the target value is therefore initialized to a value that is greater than this lowest electrical moment. In an advantageous embodiment, the target value is initialized to the value that was present before the occurrence of the fault, i.e. the value before the occurrence of the fault is, as it were, frozen. The initialization may be effected at the instant at which the fault occurs.

In a preferred design, the initialization of the target value is effected in dependence on the difference between a setpoint rotational speed and an actual rotational speed before the grid fault. This has the advantage that the characteristic before the grid fault is still taken into account. As a rule, the characteristic before the grid fault will be such that the voltage, starting from 100%, has dropped to the lower limit of normal operation (for example, 80%). Correspondingly less electrical energy could be delivered to the grid, such that the electrical moment has to be reduced accordingly. This results in an increase in the rotational speed that is integrated by the moment closed-loop controller, since it is just not possible to counteract the acceleration by an increased electrical moment. If the start of the grid fault is defined as the instant at which the voltage falls below the lower limit of normal operation, the moment closed-loop controller can be initialized, for example, to the target value that was present at that instant.

Since reliable open-loop control of the wind turbine is not possible during the grid fault, the operation of the moment closed-loop controller can be interrupted during the grid fault. The target value is then no longer determined, as in normal operation, on the basis of a deviation between an actual value and a setpoint value of the controlled variable, but in another manner. For example, the target value may be frozen to the value that was present before the occurrence of the grid fault, or the target value is initialized at an appropriate instant, i.e. set to a target value determined in another manner. Following the activation, the moment closed-loop controller is in normal operation, i.e. the target value is determined on the basis of a deviation between an actual value and a setpoint value of the controlled variable.

The activation of the moment closed-loop controller may be effected after the end of the grid fault. The initialization of the moment closed-loop controller may also occur at the same instant. The end of the grid fault may be defined, for example, such that the voltage is again above the lower limit of normal operation. Preferably, the moment closed-loop controller and the moment ramp are activated simultaneously with the exceeding of this limit. The initialization may also be effected upon the limit being exceeded. The activation of the moment closed-loop controller may also be effected between the start and the end of the grid fault.

It is also possible for the moment closed-loop controller to be already activated before the grid fault, for example at the instant at which the wind turbine was last put into operation from standstill. The moment closed-loop controller may remain in operation during the grid fault, such that the target value continues to be determined in dependence on a deviation between an actual value and a setpoint value of the controlled variable. In view of the exceptional conditions during the grid fault, this frequently results in there being a large deviation between the target value and the actual value of the controlled variable. This can be accepted, however, since, after the end of the grid fault, the moment setpoint value is controlled along the moment ramp. Large upward deviations of the target value thus do not directly influence the moment setpoint value. The method, according to the invention, of operating the moment closed-loop controller includes all stated possibilities for activating the moment closed-loop controller.

It has been found that the closed-loop control result can be yet further improved if the moment setpoint value according to the invention, resulting from the moment closed-loop controller controlled along the moment ramp, is combined with the output variable of an additional closed-loop controller, in order to determine the actual specified value for the electrical moment. The additional closed-loop controller may comprise a P component, and is preferably a pure P controller. P component means that the output variable is proportional to the input variable. The input variable is preferably the difference between the setpoint rotational speed and the actual rotational speed of the wind turbine. For example, the output variable of the additional closed-loop controller and the moment setpoint value may be combined by means of a summing unit. The additional closed-loop controller may be activated simultaneously with the moment closed-loop controller according to the invention. Upon activation, the output variable of the additional closed-loop controller may be initialized to zero. The moment closed-loop controller and the additional closed-loop controller may be combined in a structural unit.

In order to bring the closed-loop control result yet closer to the ideal characteristic, the additional closed-loop controller may be provided with a correction element, which delivers an output variable that depends on the difference between the electrical moment before the occurrence of the grid fault and the minimum value of the electrical moment during the grid fault. The correction element is preferably deactivated after a predefined period of time from the end of the grid fault. The period of time may be, for example, between 1 s and 4 s.

It is possible, within the scope of the invention, to use, after the grid fault, a moment closed-loop controller and/or additional closed-loop controller specially designed for the fault case. It is more advantageous, however, if the moment closed-loop controller and/or the additional closed-loop controller, apart from the modifications according to the invention, are the same as those that were also used to influence the electrical moment of the wind turbine before the occurrence of the grid fault. In particular, the time constant of the moment closed-loop controller may remain unchanged.

The moment ramp according to the invention is intended, in particular, to prevent a vibration phenomenon of the drive train of the wind turbine, that is already in action in any case, from being amplified further by an abrupt change in the electrical moment. On the other hand, an abrupt change in the electrical moment may be entirely desirable if the vibration phenomenon is thereby counteracted, i.e. if the vibration is damped. In this connection, it is particularly the first rise of the vibration, after the occurrence of the grid fault, that is of interest. Since the electrical load is absent during the grid fault, the direction in which the drive train vibrates in this phase is known. An abrupt increase in the electrical moment in this phase will cause damping of the vibration.

An aspect of the invention is therefore to wait for a predefined period of time, after the occurrence of the grid fault, before activation of the moment closed-loop control that dampens the vibration. The predefined period of time is preferably dependent on the duration of the rise of the drive train vibration, and in particular is not longer than this duration. For example, the period of time may be between 100 ms and 200 ms, preferably between 120 ms and 160 ms. This corresponds to the rise of the drive train vibration in the case of a larger wind turbine. The concept of a barrier, provided for the moment closed-loop controller, initially being left inactive after the end of the grid fault, has inventive substance in its own right, even without the moment closed-loop controller and the moment ramp according to the invention being activated, and a comparison being effected between the two.

Even after the activation of the moment closed-loop controller, the vibrations in the drive train can still be influenced by means of the method according to the invention. For this purpose it is possible to use a damping module, which is present in any case for normal operation, and which emits a control signal in opposition to the drive train vibration. The control signal may be combined with the moment setpoint value determined according to the invention, in order to determine the actual specified value for the electrical moment. A summing unit, for example, may be used for the combining operation. In this case, the gain of the control signal may be increased, relative to normal operation, by at least a factor of 2, preferably at least by a factor of 5, more preferably at least by a factor of 8. A barrier element may be provided for the control signal, in order to ensure that the control signal remains within the allowable range. For example, the lower barrier of the barrier element may be 0%, and the upper barrier 100%, of the electrical moment that is allowable for the wind turbine.

In particular, for the purpose of damping the vibrations of the drive train, the first two half-waves after the end of the grid fault may be used. Thereafter, the damping module may again be operated with a normal gain factor. The period of time within which the increased gain is active after the end of the grid fault may be, for example, between 0.2 s and 0.8 s. Upon expiry of the period of time, the increased gain may be inactivated. The concept of taking into the account the damping module, after the end of a grid fault, with an increased gain factor, has inventive substance in its own right, even without the moment closed-loop controller and the moment ramp according to the invention being activated, and a comparison being effected between the two.

If the moment setpoint value and the actual specified value for the electrical moment are determined according to the method according to the invention, a series of differing input variables, which are not entirely easily combined, may ensue. In order, nevertheless, to keep the closed-loop control safely within the allowable range, a limiter may be provided, which defines an allowable range for the electrical moment. If the moment setpoint value is greater than the upper limiting value, the moment setpoint value is set to the upper limiting value. If the moment setpoint value is less than the lower limiting value, the moment setpoint value is set to the lower limiting value. The limiter is preferably applied as a final step to the moment setpoint value, such that, after the limiter, the actual specified value for the electrical moment is obtained.

The lower limiting value may correspond, for example, to the minimum value of the electrical moment that was present during the fault. The upper limiting value may correspond, for example, to 110% of the electrical moment that was present before the occurrence of the grid fault. The limiter is preferably active only within a predefined period of time after the end of the grid fault. In this case, the lower limit of the limiter may be removed earlier than the upper limit. The period of time within which the upper limit is maintained should be selected such that transient phenomena have decayed. For example, the period of time for the upper limit may be between 3 s and 8 s. In the case of the lower limit, it must be taken into account that the closed-loop controller is to be given the freedom to adjust the electrical moment downward if the wind abates. The period of time for the lower limit is therefore preferably less than 2 s, more preferably less than 1 s.

The invention additionally relates to a wind turbine having a grid fault detector that is designed to output a signal upon the occurrence of a grid fault. An open-loop control system is provided, which is designed to initialize a moment ramp after the occurrence of a grid fault. The wind turbine additionally comprises a moment closed-loop controller, which determines a target value for the electrical moment of the wind turbine. The target value and the moment ramp are supplied to a minimum element, which outputs the lesser of the two values as a moment setpoint value. A converter is designed to set the electrical moment of the wind turbine on the basis of the moment setpoint value. The wind turbine may be enhanced with further features, which are described with reference to the method according to the invention. In particular, the open-loop control system is preferably designed such that it activates the moment closed-loop controller before the start of the grid fault, between the start and the end of the grid fault or after the end of the grid fault.

### BRIEF DESCRIPTION OF THE DRAWINGS

The invention is described exemplarily in the following with reference to the appended drawing, on the basis of advantageous embodiments. There are shown in:

FIG. 1: a schematic representation of a wind turbine according to the invention;

FIG. 2: a block diagram of an embodiment of a closed-loop controller of the wind turbine according to the invention;

FIG. 3: a comparison of the closed-loop controller result of the method according to the invention with a method from the prior art;

FIG. 4: a block diagram of another embodiment of a closed-loop controller according to the invention;

FIG. 5: a comparison of the closed-loop controller result in the case of two differing grid faults; and

FIG. 6: a block diagram of a further embodiment of a closed-loop controller according to the invention.

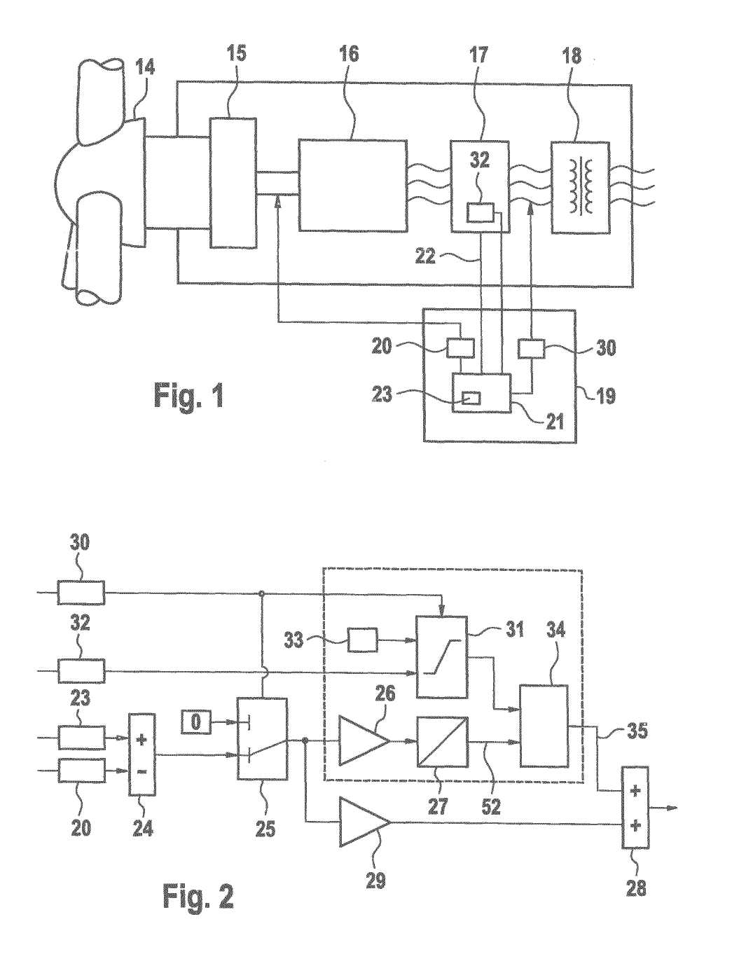

### DETAILED DESCRIPTION

In the case of a wind turbine according to the invention, a rotor 14 is oriented in the direction of the wind and is made to rotate by the wind. By means of a gearbox 15, the rotation is geared up to a higher rotational speed, the output shaft of the gearbox 15 constituting the input shaft of a generator 16. Via a converter 17, the electrical energy is routed to a transformer 18, which transforms the electrical energy to a higher voltage, and outputs it to an electricity grid, not represented.

The wind turbine comprises an open-loop control system 19, which sets the electrical moment of the wind turbine when the wind turbine is in normal operation. For this purpose, the open-loop control system 19 comprises a closed-loop controller 21, which transmits to the converter 17, via a control line 22, specified values according to which the converter 17 sets the electrical moment that acts upon the drive train. The closed-loop controller 21 includes a memory 23, in which a respective setpoint rotational speed is stored for the various operating states of the wind turbine. For the purpose of determining the actual rotational speed of the drive train of the wind turbine, the open-loop control system 19 comprises a rotational speed sensor 20.

As an input variable, the closed-loop controller 21 uses the difference from the actual rotational speed and the setpoint rotational speed. This difference is supplied to a P element and an I element of the closed-loop controller, which in each case determine an output value from the difference. After appropriate weighting, the output values are combined by means of a summing unit and then supplied, as a specified value for the electrical moment, to the converter 17.

According to the invention, the closed-loop controller 21 is also used for controlling the torque by closed-loop control after a grid fault. This requires some modifications to the closed-loop controller 21, which are represented in the block diagram of FIG. 2. The difference from the actual rotational speed from the rotational speed sensor 20 and the setpoint rotational speed from the memory 23 is determined by means of a subtraction element 24. The output value of the subtraction element 24 is supplied to the I element and the P element of the closed-loop controller, via a switch 25. The I element comprises an amplifier 26, from which the gain factor Ki of the I component is obtained, and the integrator 27, which sums the difference between the actual and the setpoint over time.

When the wind turbine is in normal operation, the output value of the integrator 27 is supplied directly to a summing unit 28, in which the combination with the output value of the P element is effected. The output value of the P element is obtained from the amplifier 29, which defines the gain factor Kp of the P element.

For the purpose of controlling torque by closed-loop control after a grid fault, the open-loop control system 19 is equipped with a grid fault detector 30. The grid fault detector 30 measures the voltage at the output of the converter 17, and emits a fault signal if the voltage falls below the lower limit of normal operation. The lower limit of normal operation may be set, for example, to 80% of the nominal voltage.

The fault signal of the grid fault detector 30 is routed to the switch 25 and to a moment ramp 31. The switch 25 is switched over when the fault signal is present at the input, thereby causing the input variable of the P element and of the I element to be set in an enforced manner to the value zero. In the case of the P element, this has the result that the output value is also zero. In the case of the I element, the output value becomes frozen, i.e. remains constant on the value at the instant of the fault signal. In the moment ramp 31, initially nothing happens when the fault signal is present at the input.

If the voltage recovers after the grid fault has ended, which in many cases happens within fractions of seconds, the voltage again rises beyond the lower limit of normal operation, and the grid fault detector 30 no longer emits a fault signal. With the cessation of the fault signal, the switch 25 returns to its original state, such that the difference between actual rotational speed and setpoint rotational speed, determined by means of the subtraction element 24, again constitutes the input variable for the I element 26, 27 and the P element 29. In the I element 26, 27, summing now progresses, starting with the value, before the occurrence of the fault, to which the I element 26, 27 was frozen. In the case of the P element 29, quite normally, the output variable is proportional to the input variable.

In addition, with the cessation of the fault signal, the moment ramp 31 is initialized. Apart from having the input for the fault signal, the moment ramp 31 has two inputs, namely, firstly an input that is connected to a moment memory 32 of the converter 17, and secondly an input that is connected to a time-constant memory 33. The moment memory 32 stores the minimum value of the electrical moment that could still be applied during the grid fault. The electrical moment that can be applied by the converter 17 depends directly on the voltage present at the converter, such that the minimum value is an indicator for the gravity of the grid fault.

In the moment ramp 31, these two input values are used to define a function, rising linearly with time, which starts, at the instant of initialization, with the minimum value of the electrical moment, and then rises, with the slope defined by the time constant, to the maximum electrical moment allowable for this wind turbine. The time constant may be selected, for example, such that the rise extends over 0.3 s. The respective time-variable value is present at the output of the moment ramp 31, and is routed, as a comparison value, to the input of a minimum element 34.

The output value of the I element 26, 27 is present at the second input of the minimum element 34. The minimum element 34 compares this output value with the comparison value of the moment ramp 31, and outputs the lesser of the two values. The output value of the minimum element 34 is routed, as a moment setpoint value 35, to the summing unit 28, and there it is combined with the output value of the P element 29. The output value of the summing unit 28 is routed, as a specified value for the electrical moment, to the converter 17.

The I element 26, 27 constitutes the moment closed-loop controller within the meaning of the invention, the output value 52 of the I element 26, 27 constituting, within the meaning of the invention, the target value for the electrical moment. The moment setpoint value 35 according to the invention is determined by means of the combination composed of the I element 26, 27, the moment ramp 31 and the minimum element 34, which in FIG. 2 are bounded by a broken line. Within the meaning of the invention, the P element 29 constitutes the additional closed-loop controller, whose output value is combined with the moment setpoint value in order to determine the actual specified value for the electrical moment. The activation of the I element 26, 27 is effected, upon the cessation of the fault signal, when the difference between the actual rotational speed and the setpoint rotational speed is again supplied, as an input value, to the I element 26, 27. The initialization of the moment ramp 31 is likewise effected upon the cessation of the fault signal, in that the moment ramp 31 is set to the minimum value of the electrical moment during the fault, and the time course of the ramp is started with the time constant from the memory 33.

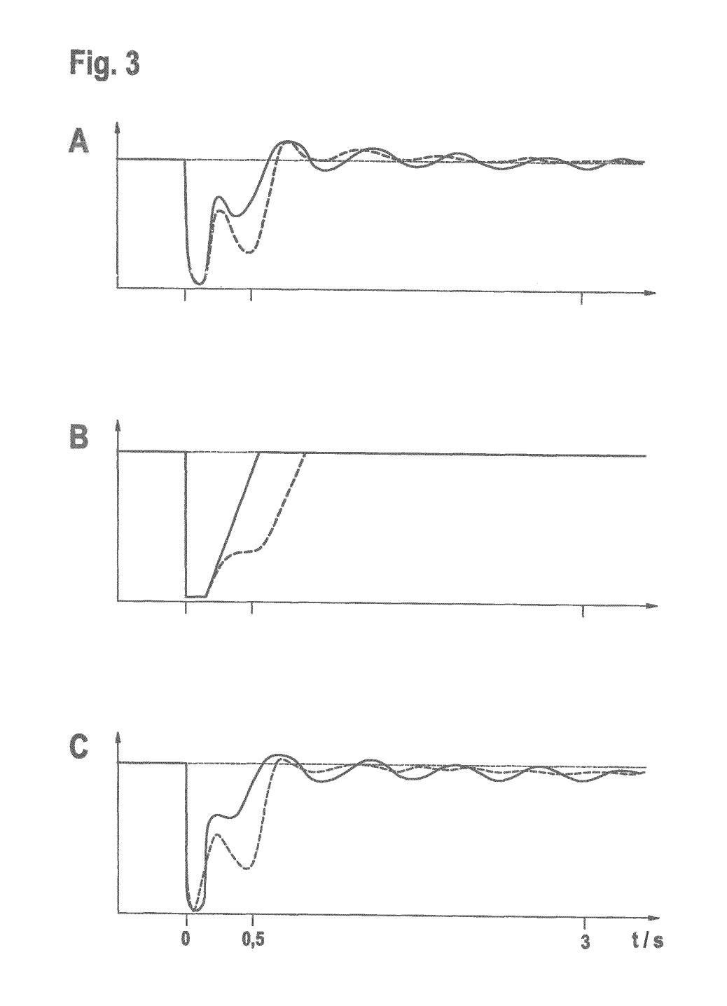

The time characteristic that is obtained with a closed-loop controller according to FIG. 2 after a grid fault is represented exemplarily in FIG. 3. In this figure, FIG. 3A shows the time characteristic of the electric power output by the converter 17, FIG. 3B shows the time characteristic of the moment setpoint value 35 at the output of the minimum element 34, and FIG. 3C shows the time characteristic of the specified value for the electrical moment at the output of the summing unit 28. Two curves are compared in each case, the unbroken line showing the behavior of the closed-loop controller according to the invention, and the broken line showing, for comparison, the behavior of a closed-loop controller from the prior art, in which the I element is initialized to zero after the grid fault and the time constant of the I element is increased, in order to avoid vibrations.

The matter in question is the extreme case of a fault in which, at the instant t=0 s, the voltage collapses from 100% to 0% of the nominal voltage. After approximately 0.15 s the voltage has recovered to such an extent that the lower limit of normal operation is exceeded. For the closed-loop controller from FIG. 2 this means that, at the instant t=0 s, the grid fault detector 30 emits a fault signal, which ceases again at the instant t=0.15 s.

It is evident in FIG. 3B that the moment setpoint value 35 moves exactly along the moment ramp 31. As a result of the output value of the P element 29 having been superimposed, an intermediate counter-control downward is obtained in FIG. 3C. This results from the fact that the P element 29 serves simultaneously to counteract vibrations of the drive train. The recovery of the power in FIG. 3A substantially follows the specified value of the electrical moment from FIG. 3C. It is evident that the recovery of the power is effected considerably more rapidly with the closed-loop controller according to the invention than with the closed-loop controller from the prior art.

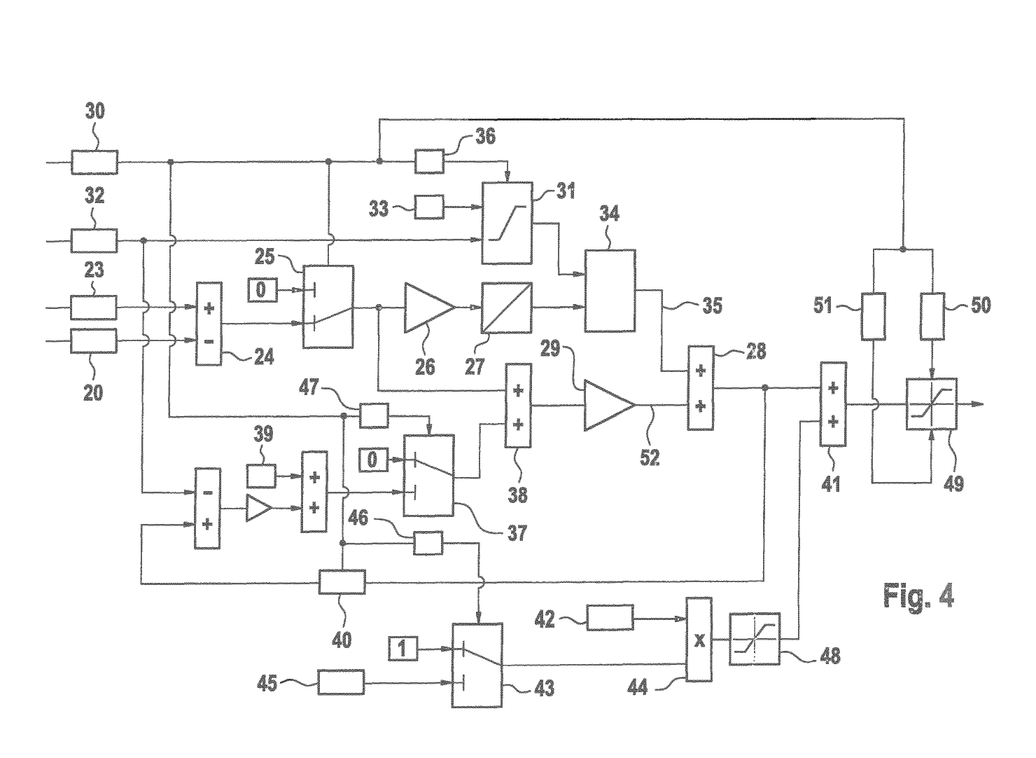

A further variant of the closed-loop controller according to the invention is shown in FIG. 4. In the closed-loop controller shown therein, all elements of the closed-loop controller from FIG. 2 have been identically retained, and only some elements have been added.

Firstly, the signal line from the grid fault detector 30 to the moment ramp 31 has been provided with a TON element 36. The TON element 36 is a delay element, by which a change from 0 to 1 that occurs at the input is forwarded to the output only after a predefined time delay. A change from 1 to 0, on the other hand, is transmitted without a time delay.

The TON element 36 has the effect that the initialization of the moment ramp 31 does not occur if the grid fault has already ended again before the expiry of the delay predefined by the TON element 36. The delay of the TON element 36 is such that it corresponds to the first rise of the drive-train vibration. For a wind turbine of between 3 MW and 4 MW, the delay may be, for example, 140 ms. If the moment ramp 31 is not put into operation, the output of the I element 26, 27 is not limited by the moment ramp, and the non-limited output value of the I element 26, 27 is present at the output of the minimum element 34. The converter 17 can thus use full electrical moment to effect control against the drive-train vibration.

In addition, the closed-loop controller in FIG. 4 is provided with a correction element, which comprises a switch 37 whose output is combined with the P element 29 by means of a summing unit 38. In normal operation, the switch 37 is switched to 0, such that the correction element has no influence upon the closed-loop control As soon as a fault signal from the grid fault detector 30 is present at the switch 37, the latter switches to the other input. Present there is the sum from a fixedly set correction value from the memory 39 and a differential value between the setpoint value of the electrical moment before the occurrence of the grid fault and the minimum value of the electrical moment during the grid fault. The correction element obtains the minimum value from the moment memory 32 of the converter 17. The setpoint value before the occurrence of the fault originates from a hold element 40, which is likewise activated by the fault signal of the grid fault detector 30. The correction element opens up the possibility of selectively adapting the closed-loop controller to the particularities of individual wind turbines.

The period of time for which the correction element remains active after the grid fault is determined by a TOF element 47. A TOF element is a delay element, by which a change from 1 to 0 that occurs at the input is forwarded to the output only after a predefined time delay. A change from 0 to 1, on the other hand, is transmitted without a time delay. In the present example, the delay of the TOF element 47 may be, for example, 3 s, such that, after the grid fault, the post-vibrations have already largely decayed.

The closed-loop controller according to FIG. 4 additionally comprises a damper module, the output value of which is combined with the moment setpoint value, by means of summing unit 41. The damper module comprises an initially conventional damper 42, such as that typically used in a wind turbine, in order to counteract, by means of the electrical moment, the vibrations of the drive train 14, 15, 16. The weighting with which the output value of the damper 42 is superimposed on the moment setpoint value is set by means of a switch 43 and a multiplier 44. When the wind turbine is in normal operation, the value 1 is present at the switch 41, such that the damper 42 is taken into account with normal weighting. If the fault signal from the grid fault detector 30 is present at the switch 43, the switch 43 is switched over to the other input. A factor by which the weighting of the damper 42 is increased is read out from the memory 45. The factor may have the value 10, for example, such that the effect of the damper 42 is increased by a multiple. The output value of the multiplier 44 is routed through a barrier element 48, in order to ensure that the limits, between 0% and 100% of the allowable electrical moment, are maintained. A TOF element 46 defines the period of time for which the weighting of the damper 42 remains increased. The period of time may correspond, for example, to a full wave of a drive-train vibration. In the case of larger wind turbines, having an output of some megawatts, the period of time could be, for example, 0.5 s.

Finally the closed-loop controller in FIG. 4 comprises a limiter 49, by which it is ensured that the specified value for the electrical moment is kept within predefined limits. In the present example, the lower limit corresponds to the minimum value of the electrical moment during the grid fault. The upper limit is fixed at 110% of the electrical moment before the occurrence of the grid fault. The period of time during which the limiter 49 remains active after the grid fault is defined separately by two TOF elements 50, 51, for the upper limiting value and the lower limiting value. In the present example, the lower limiting value becomes inactive after 1 s, such that the closed-loop controller is given the possibility of reducing the electrical moment if the wind has abated in the interim. The upper limit remains active for 5 s, such that the transient phenomena after the grid fault have abated.

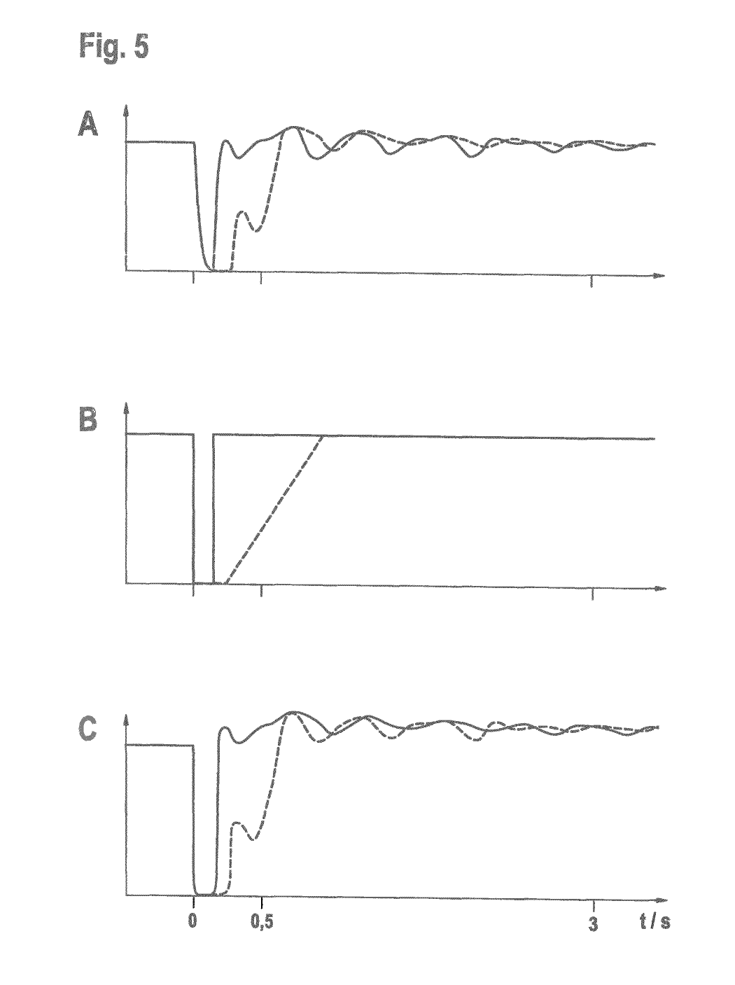

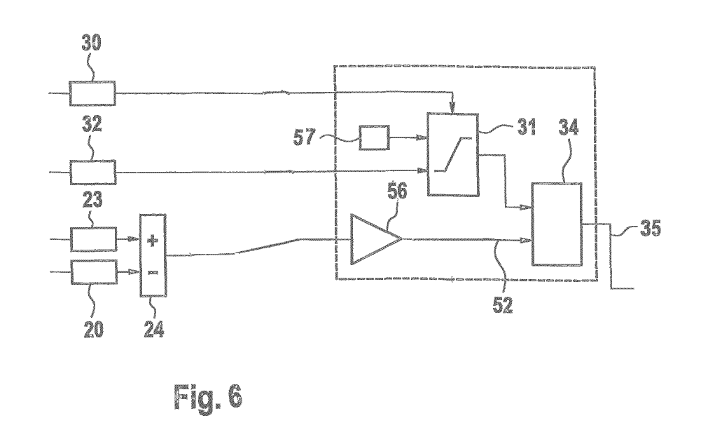

FIG. 5 shows the behavior of the closed-loop controller from FIG. 4 as a function of time, in the case of two differing types of grid fault. In this case, FIG. 5A shows the time characteristic of the electric power output by the converter 17, FIG. 5B shows the time characteristic of the moment setpoint value 35 at the output of the minimum element 34, and FIG. 5C shows the time characteristic of the specified value for the electrical moment at the output of the limiter 49. The unbroken line relates to a grid fault that has ended after 150 ms. In the case of the broken line, the grid fault lasted 200 ms.

The grid fault lasting 150 ms is below the delay of the TON element 36, such that the moment ramp 31 is not activated in this case. The setpoint value for the electrical moment therefore rises abruptly, with the consequence that the electric power also recovers immediately. The abrupt change is desirable, because it opposes the vibration of the drive train that is just then building up. Accordingly, FIGS. 5A and 5C show that the post-vibrations are not more pronounced than in the case of the slower recovery of the power in the comparison example.

In the case of the fault lasting 200 ms, the moment ramp 31 becomes active, and the time characteristic represented by the broken line is similar to that from FIG. 3.

A further embodiment of a closed-loop controller according to the invention is shown in FIG. 6, and corresponds largely to the embodiment according to FIG. 2. The difference from the actual rotational speed from the rotational speed sensor 20 and the setpoint rotational speed from the memory 23 is determined by means of a subtraction element 24. The output value of the subtraction element 24 is supplied to a closed-loop controller 56, which comprises a P element and an I element. When the wind turbine is in normal operation, the output value of the closed-loop controller 56 is used directly as a moment setpoint value.

For the purpose of controlling torque by closed-loop control during and after a grid fault, the closed-loop controller 19 is equipped with a grid fault detector 30. The grid fault detector 30 measures the voltage at the output of the converter 17, and outputs a fault signal if the voltage falls below the lower limit of normal operation.

The fault signal of the grid fault detector 30 is routed to the moment ramp 31. If the voltage recovers after the grid fault has ended, which in many cases happens within fractions of seconds, the voltage again rises beyond the lower limit of normal operation, and the grid fault detector 30 no longer emits a fault signal. With the cessation of the fault signal, the moment ramp 31 is initialized. From a memory 32, the moment ramp 31 obtains information concerning the duration of the fault and the minimum value of the electrical moment during the fault. On the basis of this information, a time-constant module 57 selects appropriate time constants for a first moment ramp and a second moment ramp, the first moment ramp being determined to limit the P component of the closed-loop controller 56, and the second moment ramp being determined to limit the I component of the closed-loop controller 56. The output values of the two moment ramps, which rise as a function of time, are routed, as a comparison value, to the input of the minimum element 34.

The output values of the P component and of the I component of the closed-loop controller 56 are present at the second input of the minimum element 34. The minimum element 34 compares these output values with the comparison value of the respectively associated moment ramp, and outputs the lesser of the two values. The output value of the minimum element 34 is routed, as a moment setpoint value 35, to the converter 17.

The closed-loop controller 56 constitutes the moment closed-loop controller within the meaning of the invention, the output value 52 of the closed-loop controller 56 within the meaning of the invention constituting the target value for the electrical moment. The moment setpoint value 35 according to the invention is determined by means of the combination composed of the closed-loop controller 56, the moment ramp 31 and the minimum element 34, which in FIG. 6 are bounded by a broken line.

1. A method for controlling the electrical moment of a wind turbine by closed-loop control in the event of a grid fault, comprising the following steps:
a. discovering a fall in voltage that is outside the limits of normal operation;
b. initializing a moment ramp (31);
c. comparing a target value (52) of a moment closed-loop controller (26, 27) with the moment ramp (31);
d. selecting the lesser value from step c. as a moment setpoint value (35); and
e. setting the electrical moment of the wind turbine on the basis of the moment setpoint value (35).

2. The method of claim 1, wherein the moment ramp (31) rises from an initial value to an end value, and the initial value is set in dependence on the minimum value (32) of the electrical moment during the grid fault and/or in dependence on the duration of the grid fault.

3. The method of claim 1, wherein the moment closed-loop controller (26, 27, 56) comprises a P component and/or an I component.

4. The method of claim 3, wherein the target value of the P component is compared with a first moment ramp, and the target value of the I component is compared with a second moment ramp.

5. The method of claim 1 wherein the moment closed-loop controller (26, 27, 56) is activated before the start of the grid fault, between the start and the end of the grid fault, or after the end of the grid fault.

6. The method of claim 1 wherein the moment setpoint value (35) is combined with the output variable of an additional closed-loop controller (29), and the additional closed-loop controller (29) comprises a P component whose input variable is the difference between a setpoint rotational speed (23) and an actual rotational speed (20) of the wind turbine.

7. The method of claim 6, wherein a correction value, which depends on the difference between the electrical moment (40) before the occurrence of the grid fault and the minimum value (32) of the electrical moment during the grid fault, is applied to the additional closed-loop controller (29).

8. The method of claim 1 wherein the same moment closed-loop controller (26, 27, 56) and/or additional closed-loop controller (29) are/is used as before the occurrence of the grid fault.

9. The method of claim 1 wherein the moment closed-loop controller (26, 27, 56) is activated only when the grid fault has ended and a predefined period of time has passed since the occurrence of the grid fault.

10. The method of claim 9, wherein the time period of the rise time corresponds to a vibration of the drive train (14, 15, 16) of the wind turbine.

11. The method of claim 1 wherein a damper module (42, 43, 45) is provided, which emits a control signal in opposition to the drive train vibration, and the control signal is provided with an increased gain factor in comparison with normal operation, and is combined with the moment setpoint value (35).

12. The method of claim 1 wherein a limiter (49) is applied to the moment setpoint value (35), wherein the lower limiting value is set in dependence on the minimum value (32) of the electrical moment during the grid fault, and the upper limiting value is set in dependence on the electrical moment before the occurrence of the grid fault.

13. The method of claim 12, wherein a first period of time (51) after the end of the grid fault is provided, after which the lower limiting value is deactivated, and a second period of time (50) after the end of the grid fault is provided, after which the upper limiting value is deactivated, wherein the first period of time (51) is shorter than the second period of time (50).

14. A wind turbine, having a grid fault detector (30), having an open-loop control system (19), which is designed to initialize a moment ramp (31) after the occurrence of a grid fault, and having a moment closed-loop controller (26, 27, 56), which determines a target value (52) for the electrical moment of the wind turbine, having a minimum element (34), which effects a comparison between the target value (52) and the moment ramp (31), and which outputs the lesser value as a moment setpoint value (35), and having a converter (17), which is designed to set the electrical moment of the wind turbine on the basis of the moment setpoint value (35).
